(19) United States
(12) Patent Application Publication
(10) Pub. No.: US 2007/0095193 A1
(43) Pub. Date: May 3, 2007

(54) Percussion instruments carrier assembly with changeable skins

(76) Inventor: Randall L. May, Newport Beach, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/262,238

(22) Filed: Oct. 28, 2005

(51) Int. Cl. G10D 13/02

(52) U.S. Cl. 84/421

(57) ABSTRACT

A cosmetic skin covering for a musical instrument carrier is disclosed. The cosmetic covering provides the advantages of allowing carriers to be fabricated in only one color, and prior to shipment applying the cosmetic skin to the external surface to provide customization for each consumer. Some bands may have carriers of different colors, and the skins can be applied all carries used by the band to provide a uniform appearance of the band members. The cosmetic skins are removable and or repositionable on the carrier to allow for changes, alteration, upgrade or variation of the carrier with minimal cost. The skin may be printed with a single color, multi-color pattern, school logo insignia or other indicia.

### FIELD OF THE INVENTION

This invention relates to new and useful improvements in apparatus for carrying percussion instruments, with temporary cosmetic skins covering all or some of the carrier to allow for customization, uniformity and a reduction in inventory. More particularly, the present invention relates to a temporary cosmetic covering skin that can be placed on the front of the instrument carrier, shoulder straps, back member, other visible areas and parts of a musical instrument to provide for customizing the carrier and or musical instrument without requiring each carrier to be custom fabricated in the desired color or theme.

### BACKGROUND OF THE INVENTION

Prior art discloses many examples of apparatus for supporting percussion instruments, and other prior art patents disclose protective or covering skins but none providing the combination of features disclosed and claimed herein.

Ogle et al. U.S. Pat. No. 5,322,578 discloses a process for manufacturing a protective skin for resurfacing reusable beverage containers. The process involves measuring the container and making a skin that can be wrapped around the beverage container. This patent is not intended for covering musical instruments carriers, nor does it provide the customization that allows schools or bands to have a uniform appearance.

Richards U.S. Pat. No. 6,578,303 discloses a removable display surface cover for beverage containers. This patent requires an adhesive or Velcro pad to keep the removable surface on the beverage container. This patent is not intended for covering musical instrument carriers, nor does it provide the customization that allows schools or bands to have a uniform appearance.

Web sites visionskins.com, miamiskins.com and others disclose skins for handheld consumer products such as MP3 players, cell phones and PDA's. These skins are sold to customize the products to differentiate one product from another. While these products are for skins that cover small consumer products, they are not intended for use with instrument carriers, nor are they intended to cover musical instruments. They are also sold to customize each handheld product, and are not intended to cover a quantity of products to make them all appear uniform.

La Flame U.S. Pat. No. 5,400,683 discloses a carrier for percussion instruments having an abdominal plate connected at one end of a unitary frame partly encircling the wearer at the waist and having an upstanding rear portion pivotally connected to a back pressure plate. Shoulder bars are connected to the back pressure plate, and wrap about shoulders and support straps connect to the abdominal plate, which has suitable fixtures for attachment of various percussion instruments. This invention does not disclose a cosmetic skin or covering that can change the appearance of external portions of the carrier.

May U.S. Pat. Nos. 5,691,492, 6,028,257, 6,323,407, 6,329,583 and 6,403,869 disclose various hardware for supporting percussion instruments and drums. The carriers disclosed in these patents cover vest type, T-bar and tubular constructed carrier that are constructed with surfaces that are molded or formed with a single color. These patents don't disclose covering a section of the carrier with a removable skin covering, but all of them could benefit from the skin covering disclosed herein.

The prior art discloses many examples of apparatus for supporting percussion instruments, removable or skin coverings, but none provide the combination of these two features as disclosed and claimed.

### BRIEF SUMMARY OF THE INVENTION

One of the objects of the instrument carrier with skins is to provide a new and improved carrier that allows for the carrier to be easily customized for bands such that the carriers can all have a similar appearance and or color scheme.

Another object of the instrument carrier with skins is to provide a colored or custom skin covering for musical instrument carriers that have been pre-cut to fit the various parts of the carrier. These pre-cut parts can include coverings for the belly plate, back member, shoulder straps, clamps and tubes.

Another object is to provide skins that are available in basic colors, patterns as well as making the skins available as full custom markings with a logo, slogan or design. This allows the basic carrier to take on new visual appearance with minimal cost to the user.

Another object is to provide skin material that can be temporarily installed, repositioned and removed without leaving an adhesive residue. The skin is made from a resilient conforming material that can be easily placed and spread over the surface of a carrier and it will conform to the shape of the carrier. Air bubbles that are trapped under the material can be easily pushed out to provide a smooth skin covering. Due to the adhesive used to bond the skin to the carrier, the skin can be removed and repositioned if placement of the skin on the carrier is not ideal.

Another object carrier with skin coverings is to provide skins for an instrument carrier that can also be used with musical instruments. Additional or supplemental skin covering material can be provided for covering a portion of a musical instrument. This could ideally be used with instruments with large semi-flat or curved surfaces such as drums. The skin on the musical instrument carrier and the skin on the musical instrument can be the same, complimentary or contrasting colors. A further advantage of placing a skin on a natural wood instrument is for improved humidity and moisture resistance with minimal effect on the sonic properties of the instrument.

Another object of the skin covering is the ability to modify the appearance of older carriers such they have a new or uniform appearance with newer carriers. In addition to the ability to upgrade or make the carriers appear more consistent, carriers can all be fabricated in a single color, and when an order is placed for a custom colored instrument carrier, the skin of the desired color can be added to the carrier to allow for custom colored carriers as they are being packaged for shipment.

Still another object of the instrument carrier with skin is to provide the skin with material that can glow in the dark, reflect light, change, color, and or contain lights to add additional visual appearance to the carriers.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of a vest type carrier shown with removable skin coverings on the carrier.

FIG. 2 is an isometric view of a T-bar type carrier shown with removable skin coverings on the carrier.

FIG. 3 is an isometric view of a tubular construction type carrier shown with removable skin coverings on the carrier.

FIG. 4 is an isometric view of a vest type carrier with adjustable shoulder and back members with removable skin coverings.

FIG. 5 is an isometric view of a drum with a skin on the drum head and on the shell of the drum.

FIG. 6 is an isometric view of a belly plate label that is used with the carrier shown in FIG. 2 showing one embodiment of construction of the skin.

### DETAILED DESCRIPTION

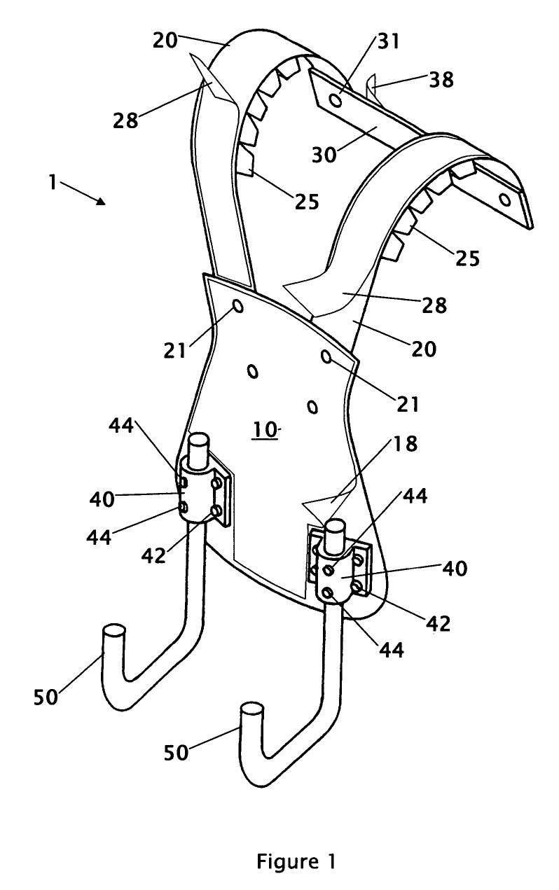

FIG. 1 is an isometric view of a vest type carrier shown with removable skin coverings. This figure shows a vest or harness-type supporting member or carrier 1 for percussion instruments which comprises a vest portion 10, shoulder straps 20 and back bar 30. A removable and repositionable skin 18 is shown covering the majority of the front surface of the vest 10. Removable and repositionable skins 28 is shown covering the outer surface of the shoulder straps 20. Back bar 30 is removably secured to shoulder straps 20 by screws or bolts 31. Where desired, back bar 30 may be fixed as by welding or the like. A removable and repositionable skin 38 is shown covering the rear facing surface of the back member 30. Vest portion 10 is removably secured to shoulder straps 20 by screws or bolts 21 and has a pair of J-rod receptacles 40 secured by screws or bolts 42. J-rods 50 are supported in receptacles 40 and secured in position by T-bolts or set screws 44. Shoulder straps 20 have pads 25 to cushion the load of the instruments carried by carrier 1.

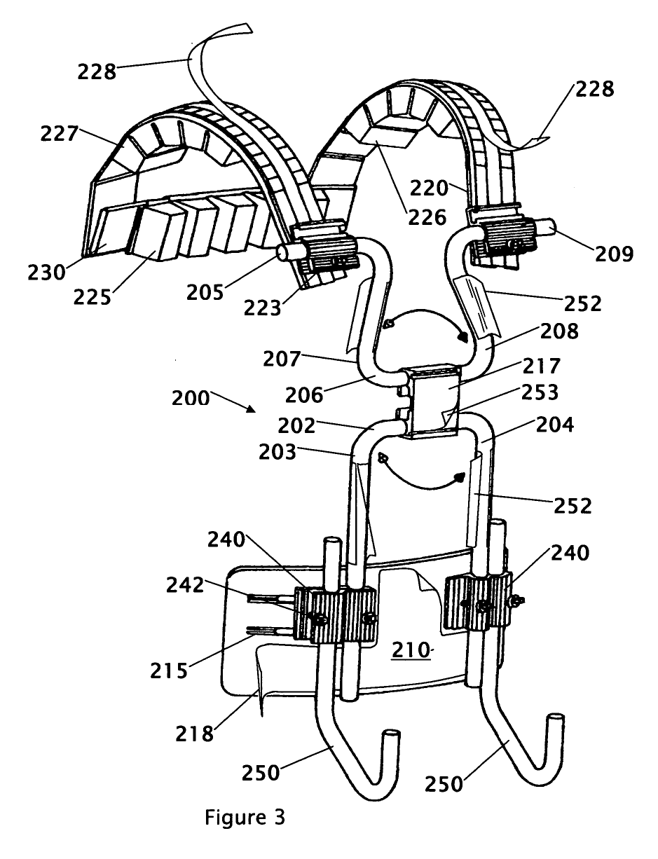

The materials of construction used in this carrier are very important for achieving the desired result. The vest portion 10 is preferably a strong, light-weight composite material such as Fiberglas®. Back bar 30 and shoulder straps 20 are rigid and made of a light metal such as aluminum, magnesium or titanium. Some prior art vests of this type have been of a one-piece Fiberglas®. construction. There were incidents of failure of the shoulder straps from repeated flexing. The metal shoulder straps do not fail in flexure and also have the advantage that different sizes are readily accommodated. The vest portion 10 can be of a single size and separate shoulder straps 20 of differing radii for small, medium, large or extra large size. The cushions 25 are of a type used to pad the interior of football and other sports helmets. Cushions have a backing strip of polyvinyl plastic film. A thin sheet of polyvinyl film encloses blocks of closed pore plastic (e.g., polystyrene or polyurethane) foam and is sealed to backing strip to enclose separate blocks. The blocks are separately compressible and provide more comfort to the wearer of the carrier when fully loaded. It should be noted that shoulder straps 20 may be made adjustable as in FIG. 3. J-rod supports may be made adjustable by loosening the set screws 44 and sliding the J-rods 50 in the clamps 40. The skins are used to provide a temporary covering of the carrier. The temporary covering provides the benefit of allowing the carriers to provide a uniform appearance. It can also be used with a logo, slogan, school colors or other indicia that unifies the members wearing the carrier. Another advantage of the skin covering is to reduce the inventory of carriers in a variety of colors and styles. Using the skins, carriers can all be fabricated in a single color, and the skins can be added as the carriers are shipped, or the skins can be shipped separately and applied by the band members.

Operation

The operation of this carrier should be apparent but will be described briefly for clarity. The carrier 1 is worn by the musician with the shoulder straps 20 positioned over the shoulders and the vest 10 supported against his abdomen. Pads 25 on shoulder straps 20 cushion the load of the instruments carried by carrier 1. Pads may also be used in padding back bar 30 or vest belly plate portion 10.

Vest 1 may have suitable padding over its inner surface, as needed, to avoid discomfort from the bolts or screws 21 used to assemble the straps to the vest or bolts or screws 42 used to assemble receptacles 40 on the vest. Back bar 30 may be removed or omitted for the convenience of drummers who prefer an open back as in some prior art drum carriers. J-rods 50 are inserted in position and secured in place by tightening set screws 44. The short outer ends of the J-rods are inserted into the J-rod receptacles on the percussion instrument being carried, e.g., drums (single or array), cymbals, xylophone, marimba, or the like.

Marching T-Bar Support for Drums and Other Percussion Instruments

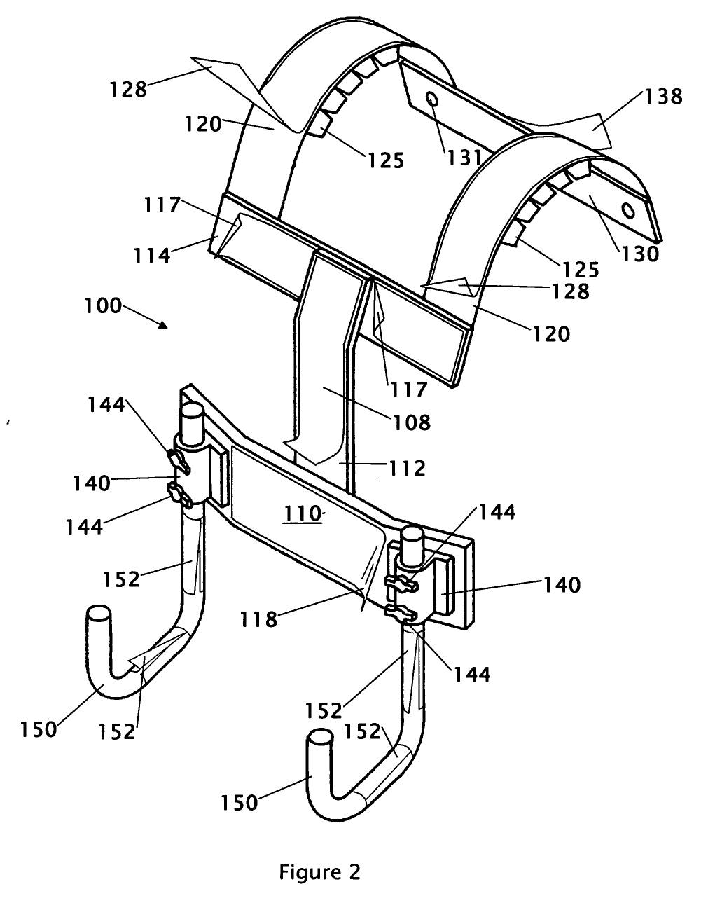

Referring to FIG. 2 showing an isometric view of a T-bar type carrier 100 shown with removable skin coverings for percussion instruments which comprises a belly plate 110, vertical bar 112, upper horizontal bar 114, shoulder straps 120 and back bar 130. Back bar 130 is removably secured to shoulder straps 120 by screws or bolts 131. Where desired, back bar 130 may be fixed as by welding or the like. Upper horizontal bar 114 is removably secured to shoulder straps 120 by screws or bolts. Upper horizontal bar 114 is removably secured to the upper end of vertical bar 112 by screws or bolts.

A removable and repositionable skin 108 is shown covering the majority of the front surface of the vertical member 112. Skin material 118 is shown covering the front surface of the belly plate 110. Two removable and repositionable skins 117 are shown covering the front surface of the horizontal member 114. Two removable and repositionable skin 128 are shown covering the outer surface of the shoulder straps 120. A removable and repositionable skin 138 is shown covering the visible outer surface of the back member 130. Skin material 152 is shown wrapped around parts of the J-rods. 150.

Belly plate 110 is removably secured to the lower end of vertical bar 112 by screws or bolts. A pair of J-rod receptacles 140 are secured on belly plate 110 by screws or bolts or the like. J-rods 150 are supported in receptacles 140 and secured in position by T-bolts 144. Shoulder straps 120 have pads 125 to cushion the load of the instruments carried by T-bar carrier 100. Pads may further be used in padding back bar 130 or vest belly plate portion 110.

The materials of construction used in this carrier 100 are very important for achieving the desired result. The belly plate 110, vertical bar 112, upper horizontal bar 114, shoulder straps 120 and back bar 130 are rigid and made of a light metal such as aluminum, magnesium or titanium. The metal shoulder straps have the advantage that different sizes are readily accommodated. The sub-assembly of the belly plate 110, vertical bar 112, upper horizontal bar 114 can be of a single size and separate shoulder straps 120 of differing radii used for small, medium, large or extra large size. The cushions 125 are of a type used to pad the interior of football and other sports helmets. The cushions are fabricated from one or separate blocks that are separately compressible and provide more comfort to the wearer of the carrier when fully loaded. It should be noted that shoulder straps 120 may be made adjustable as shown and described in FIG. 3 as well as other May patents and patent applications. The skins are used to provide a temporary covering of the carrier. The temporary covering provides the benefit of allowing the carriers to provide a uniform appearance. It can also be used with a logo, slogan, school colors or other indicia that unifies the members wearing the carrier. Another advantage of the skin covering is to reduce the inventory of carriers in a variety of colors and styles. Using the skins, carriers can all be fabricated in a single color, and the skins can be added as the carriers are shipped, or the skins can be shipped separately and applied by the band members.

Operation

The operation of this carrier should be apparent but will be described briefly for clarity. The carrier 100 is worn by the musician with the shoulder straps 120 positioned over the shoulders and the belly plate 110 supported against his abdomen. Pads 125 on shoulder straps 120 cushion the load of the instruments carried by carrier 100. Belly plate 110 and back bar 130 may have suitable padding over inner surfaces, as needed, to avoid discomfort from the bolts or screws 130 used to assemble the straps to the upper horizontal bar 114 or bolts or screws used to assemble belly plate 110 to vertical bar 112. J-rods 150 are inserted in position and secured in place by tightening T-bolts 144. The short outer ends of the J-rods are inserted into the J-rod receptacles on the percussion instrument being carried, e.g., drums (single or array), cymbals, xylophone, marimba, or the like.

FIG. 3 is an isometric view of a tubular construction type carrier shown with removable skin coverings on the carrier 200. This figure shows a tubular carrier with a hinge connection located in the front of the carrier. Lower 202 and upper 206 vertical supporting rods or tubes. Lower rod or tube 202 is U-shaped with parallel portions 203 and 204 supporting belly plate 210. Upper rod or tube 206 is U-shaped with legs 207 and 208 having out-turned portions 205 and 209 supporting rigid shoulder straps 220 and back bar 230. Back bar 230 may be removably secured to shoulder straps 220 or may be fixed as by welding or the like. Shoulder straps 220, and back bar 230 have cushions 225, 226 and 227. The cushions are of a type used to pad the interior of football and other sports helmets and are shown in more detail in issued U.S. Pat. No. 6,028,257. The cushions have a backing strip of polyvinyl plastic film. A thin sheet of polyvinyl film encloses blocks of closed pore plastic (e.g., polystyrene or polyurethane) foam and is sealed to the backing strip to enclose separate blocks which are separately compressible and provide more comfort to the wearer of the carrier when fully loaded. Belly plate 210 is removably secured on the lower ends 203 and 204 of vertical rod or tube 202 by clamping receptacles 240. J-rod receptacles 250 are secured on belly plate 210 in slots 215 by screws, bolts, or the like. J-rods 250 are secured in receptacles 240 by bolts 242. The upper, out-turned ends 205 and 209 of supporting rod or tube 206 are supported in clamping receptacles 223 on shoulder straps 220. A clamp 217 holds rods or tubes 202 and 206 in an articulated relation to permit angular flexing.

A removable and repositionable skins 218 is shown covering the majority of the front surface of the belly plate member 210. Two removable and repositionable skin 228 are shown covering the outer surface of the shoulder straps 220. Skin material 252 is shown wrapped around parts of the tubes. Skin material 253 is shown covering the connecting member 217 that connects the upper tube 206 and the lower tube 202.

The materials of construction used in this carrier 200 are very important for achieving the desired result. The belly plate 210, supporting rods or tubes 202 and 206, shoulder straps 220 and back bar 230 are rigid and made of a light metal such as aluminum, magnesium or titanium. The metal shoulder straps have the advantage that different sizes are readily accommodated.

Operation

The operation of this carrier should be apparent but will be described briefly for clarity. The carrier 200 is worn by the musician with the shoulder straps 220 positioned over the shoulders and the belly plate 210 supported against the abdomen. J-rods 250 are inserted in position and secured in place by tightening bolts 242. The short outer ends of the J-rods 250 are inserted into the J-rod receptacles on the percussion instrument being carried, e.g., drums (single or array), cymbals, xylophone, marimba, or the like.

The carrier is adjustable to the comfort of the wearer and also to fit different sized instruments. Clamp-receptacles 223 permit pivotal, lateral and angular adjustment of shoulder straps 220 on the out-turned ends 205 and 209 of rod or tube 206. Clamp-receptacles 240 permit vertical sliding adjustment of rod or tube 202. Slots 215 in belly plate 210 allow lateral adjustment of clamp-receptacles 240 and angular adjustment of J-rods 250 supported therein.

The skins are used to provide a temporary covering of the carrier. The temporary covering provides the benefit of allowing the carriers to provide a uniform appearance. It can also be used with a logo, slogan, school colors or other indicia that unifies the members wearing the carrier. Another advantage of the skin covering is to reduce the inventory of carriers in a variety of colors and styles. Using the skins, carriers can all be fabricated in a single color, and the skins can be added as the carriers are shipped, or the skins can be shipped separately and applied by the band members.

Adjustable Marching Vest Support for Drums and Other Percussion Instruments

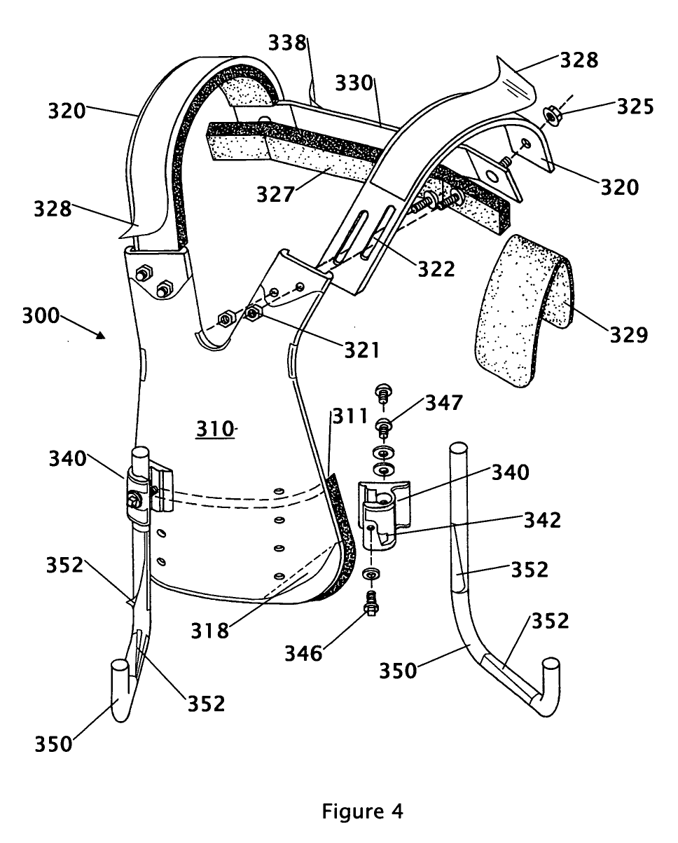

Referring to FIG. 4 that shows an isometric view of a vest type carrier 300 with adjustable shoulder and back members with removable skin coverings. The carrier for percussion instruments comprises a vest portion 310, shoulder straps 320 and back bar 330. Back bar 330 is removably secured to shoulder straps 320 by screws or bolts 325 and has padding 327. Vest portion 310 is adjustably and removably secured to shoulder straps 320 by screws or bolts 321 which extend through elongated slots 322 which permits adjustment of the straps 320 relative to vest portion 310. Shoulder straps 320 have pads 329 to cushion the load of the instruments carried by carrier 300.

Vest portion 310 has a pair of J-rod receptacles 340 secured by screws or bolts 347. J-rods 350 are supported in receptacles 340 and secured in position by square head bolts 346 which may be operated by a drum key (not shown). Receptacles 340 are cast or extruded and have an open edge portion which can flex to clamp J-rods 350 adjustably. Receptacles 340 have an inner surface that is polygonal, in this case, hexagonal, in section which provides a plurality (in this case five) of surfaces which clamp the surface of the J-rods 350. This is a superior clamping arrangement to set screws that provide only one or two point clamping contact. Holes in the base of each receptacle are used for mounting by means of bolts or screws or the like. Aligned holes receive clamping screws 347 which operate on adjustment to clamp or to release the J-rod 350.

A removable and repositionable skins 318 is shown covering the majority of the front surface of the belly plate member 310. Two removable and repositionable skin 328 are shown covering a strip on the outer surface of the shoulder straps 320. Skin material 352 is shown wrapped around parts of the tubes. Skin material 338 is shown covering the back member 330 that connects across the shoulder straps 320. A removable and repositionable skins 342 is shown covering the outer portion of the clamps 340.

The materials of construction used in this carrier 300 are very important for achieving the desired result. The vest portion 310 is preferably a strong, light-weight composite material such as Fiberglas®. Back bar 330 and shoulder straps 320 are rigid and made of a light metal such as aluminum, magnesium or titanium. Some prior art vests of this type have been of a one-piece Fiberglas®. construction. There were incidents of failure of the shoulder straps from repeated flexing. The metal shoulder straps do not fail in flexure and also have the advantage that different sizes are readily accommodated. The vest portion 310 can be of a single size and separate shoulder straps 320 of differing radii for small, medium, large or extra large size may be used or the straps 320 may be adjustable is in the additional embodiments described below. The cushions 327 and 329 may be of a type used to pad the interior of football and other sports helmets as previously described.

Operation

The operation of this carrier should be apparent but will be described briefly for clarity. The carrier 300 is worn by the musician with the shoulder straps 320 positioned over the shoulders and the vest 310 supported against his abdomen. Pads 329 on shoulder straps 320 and back bar 327 cushion the load of the instruments carried by carrier 300. The straps 320 are adjustable by means of slots 322 and screws 321 and the J-rods 350 are adjustable in position by means of receptacles 340 and adjustment screws 342.

Vest 310 may have suitable padding 311 over its inner surface, as needed, at the belly plate or at suitable locations to avoid discomfort from the bolts or screws 321 used to assemble the straps to the vest or bolts or screws 347 used to assemble receptacles 340 on the vest. J-rods 350 are inserted in position and secured in place by tightening set screws 346. The short outer ends of the J-rods are inserted into the J-rod receptacles on the percussion instrument being carried, e.g., drums (single or array), cymbals, xylophone, marimba, or the like.

The skins are used to provide a temporary covering of the carrier. The temporary covering provides the benefit of allowing the carriers to provide a uniform appearance. It can also be used with a logo, slogan, school colors or other indicia that unifies the members wearing the carrier. Another advantage of the skin covering is to reduce the inventory of carriers in a variety of colors and styles. Using the skins, carriers can all be fabricated in a single color, and the skins can be added as the carriers are shipped, or the skins can be shipped separately and applied by the band members.

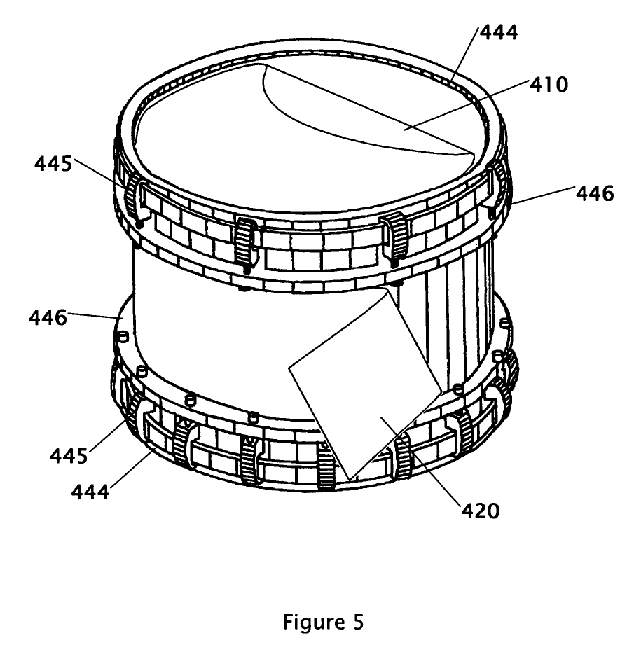

FIG. 5 shows an isometric view of a drum with skins on the drum head and the shell of the drum. In this view, the drum has drumheads 444 on opposite sides secured by drum clamps 445 to rim 446. Adaptor plates or fixtures of various types can be used to secure the drum to the carrier. Adapter that are suitable for this purpose are disclosed in prior May patents and applications. One skin is shown on the drum head 410. While placing a skin on the drum head may change the sound or sonic properties of the drum slightly, in some cases the cosmetic requirement may be more important than the sound. A second skin 420 is shown wrapped around the drum shell. The skins may be the same color patter or have the same indicia as the skin on the carrier to further provide a uniform appearance to the band. The skin may also provide the benefit of reducing the humidity effects on the drum by providing an additional sealant to a wooden drum.

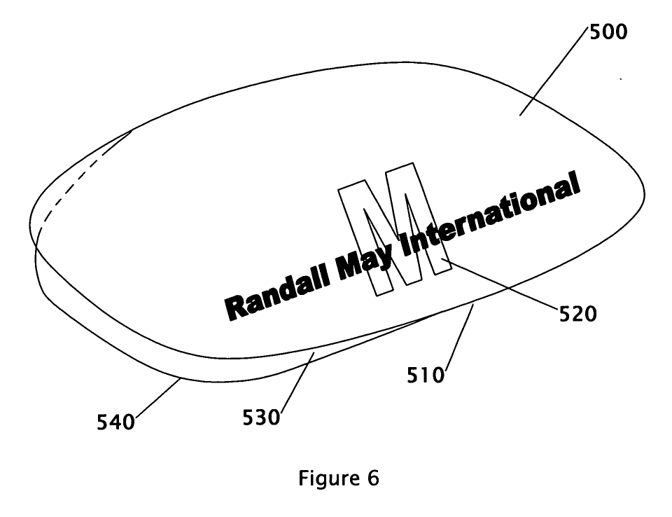

FIG. 6 is an isometric view of a belly plate label that is used with the carrier shown in FIG. 2 showing one embodiment of construction of the skin. In the preferred embodiment, the skin starts with a base material that is suitable thick that it does not tear, yet is stretchable. Material 500 that are suitable for this purpose are manufactured by Avery and others and can be found in white, clear, or colors. In the referred embodiment the material is made from a clear or transparent vinyl. The material 500 is then back or sub-surface printed with the color, logo, insignia or other indicia 520. An adhesive 530 with low adhesive properties is applied to the back surface of the label. Adhesives that are suitable for this purpose are available by 3M and others. A release liner 540 is applied to the adhesive. The required shape is then die-cut to match each of the parts of the carrier or instrument. Additional material can be made available for use on other locations such as a hat or shoes. It is also contemplated that a portion of the label material can be left un-printed and the owner's name can be placed under the window of the skin. As an alternate embodiment the skin can be printed on the top surface of the skin. When the printing is performed on the top surface of the skin the printing is more susceptible to damage. Other embodiments of the skin are contemplated such as using printing material that changes color based upon temperature, angle of viewing, holographic images and lighting systems placed in or under the skin. The properties of the adhesive are important because it allows the skin to be moved or re-positioned on the carrier or musical instrument without leaving an adhesive residue. The skins can easily be installed on older carriers and instruments to provide a newer appearance.

Thus, specific embodiments and applications for a removable cosmetic skin for an instrument carrier that allows for customization of each carrier as well as unity for a group of carriers have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A shoulder supported harness assembly for supporting musical instruments with a temporary skin covering, comprising:
a shoulder supporting section consisting of at least two shoulder supports, connected to a front section that is integrated or connected to the two shoulder supports in front of the user, an integrated, attachable or removable, back member, and a removable cosmetic skin that is configured for covering at least a portion of the shoulder supported carrier to alter the visual appearance of the carrier.

2. The shoulder supported harness assembly for supporting musical instruments with a temporary skin covering from claim 1 wherein the connection of the shoulder supports to the front section is made by a monolithic construction.

3. The shoulder supported harness assembly for supporting musical instruments with a temporary skin covering from claim 1 wherein the connection of the shoulder supports to the front section is made by screws, fasteners, welding, or clamps.

4. The shoulder supported harness assembly for supporting musical instruments with a temporary skin covering from claim 1 wherein the connection of the shoulder supports to the front section is adjustable.

5. The shoulder supported harness assembly for supporting musical instruments with a temporary skin covering from claim 1 wherein the connection of the shoulder supports to the back member is made by a monolithic construction.

6. The shoulder supported harness assembly for supporting musical instruments with a temporary skin covering from claim 1 wherein the connection of the shoulder supports to the back member is made by screws, fasteners, welding, or clamps.

7. The shoulder supported harness assembly for supporting musical instruments with a temporary skin covering from claim 1 wherein the removable cosmetic skin is transparent, colored, and or is inscribed with a logo, slogan or other indicia.

8. A shoulder supported musical instruments carrier, with a kit for customizing the appearance of the carrier comprising:
a shoulder supporting section consisting of at least two shoulder supports, connected to a front section that is integrated of connected to the two shoulder supports in front of the user, an integrated, attachable, or removable back member, and a kit containing at least one colored skin that can be temporarily contoured over at least a portion of the instrument carrier to alter the visual appearance of the carrier.

9. The shoulder supported musical instruments carrier, with a kit for customizing the appearance of the carrier from claim 8 wherein the connection of the shoulder supports to the front section is made by a monolithic construction.

10. shoulder supported musical instruments carrier, with a kit for customizing the appearance of the carrier from claim 8 wherein the connection of the shoulder supports to the front section is made by screws, fasteners, welding, or clamps.

11. The shoulder supported musical instruments carrier, with a kit for customizing the appearance of the carrier from claim 8 wherein the connection of the shoulder supports to the front section is adjustable.

12. The shoulder supported musical instruments carrier, with a kit for customizing the appearance of the carrier from claim 8 wherein the connection of the shoulder supports to the back member is made by a monolithic construction.

13. The shoulder supported musical instruments carrier, with a kit for customizing the appearance of the carrier from claim 8 wherein the connection of the shoulder supports to the back member is made by screws, fasteners, welding, or clamps.

14. The shoulder supported musical instruments carrier, with a kit for customizing the appearance of the carrier from claim 8 wherein the removable cosmetic skin is transparent, colored, and or is inscribed with a logo, slogan or other indicia.

15. A temporary cosmetic skin covering for a shoulder supported musical instrument carrier comprising:
an abrasion resistant top surface,
a cosmetic inner surface,
a repositionable adhesive lower surface, and
a skin that is preformed to conform to at least a portion of the shape of a shoulder supported musical instrument carrier to alter the cosmetic appearance of the carrier.

16. The temporary cosmetic skin covering for a shoulder supported musical instrument carrier from claim 15 wherein the abrasion resistant top surface is sufficiently transparent or translucent to allow the cosmetic inner surface to be visible.

17. The temporary cosmetic skin covering for a shoulder supported musical instrument carrier from claim 15 wherein the cosmetic inner surface is includes one or more colors, or indicia.

18. The temporary cosmetic skin covering for a shoulder supported musical instrument carrier from claim 15 wherein the repositionable adhesive allows the cosmetic skin to be removed, re-positioned, and or re-applied without leaving an adhesive residue.

19. The temporary cosmetic skin covering for a shoulder supported musical instrument carrier from claim 15 wherein the skin is preformed to cover one or more of the front of the carrier, shoulder straps, back member, J-rods, tubes, clamps.

20. The temporary cosmetic skin covering for a shoulder supported musical instrument carrier from claim 15 that further includes additional skin material with the same cosmetic appearance that can be used to alter the cosmetic appearance of a musical instrument.
